(19) United States
(12) Patent Application Publication
(10) Pub. No.: US 2026/0203659 A1
(43) Pub. Date: Jul. 16, 2026

(54) METHOD AND ELECTRONIC DEVICE WITH MODEL GENERATION AND EVALUATION

(71) Applicants: SAMSUNG ELECTRONICS CO., LTD., Suwon-si (KR); Université de Montréal, Montreal (CA); Mila - Québec Artificial Intelligence Institute, Montreal (CA)

(72) Inventors: Jihye KIM, Suwon-si (KR); Glen BERSETH, Montreal (CA); Raj GHUGARE, Princeton, NJ (US)

(73) Assignees: SAMSUNG ELECTRONICS CO., LTD., Suwon-si (KR); Université de Montréal, Montreal (CA); Mila - Québec Artificial Intelligence Institute, Montreal (CA)

(21) Appl. No.: 19/386,883

(22) Filed: Nov. 12, 2025

(30) Foreign Application Priority Data
Jan. 13, 2025 (KR) 10-2025-0005012

(51) Int. Cl. G06N 20/00

(52) U.S. Cl. CPC G06N 20/00

(57) ABSTRACT

A processor-implemented method includes randomly generating a plurality of orderings of tasks for a plurality of tasks of a training dataset, determining, based on training a first base model using the training dataset according to each of the plurality of orderings of tasks, an evaluation information set of the first base model trained according to each of the plurality of orderings of tasks, and determining, based on the evaluation information set of the first base model trained according to each of the orderings of tasks, a piece of first target evaluation information of the first base model corresponding to the training dataset.

### CROSS-REFERENCE TO RELATED APPLICATIONS

This application claims the benefit under 35 USC § 119(a) of Korean Patent Application No. 10-2025-0005012, filed on Jan. 13, 2025 in the Korean Intellectual Property Office, the entire disclosure of which is incorporated herein by reference for all purposes.

### BACKGROUND

### 1. Field

The following description relates to a method and electronic device with model generation and evaluation.

### 2. Description of Related Art

A variety of issues that deal with input data such as images, voices, or texts may be solved using a deep learning model. Training a deep learning model may require large datasets, and it may be difficult to secure sufficient datasets for new tasks or domains or to preserve previous knowledge.

Few-shot class incremental learning (FSCIL) aims to build a model that has robust performance in one-shot or few-shot scenarios in which only a very small amount of data exists, while quickly adapting to new tasks and preventing catastrophic forgetting. However, in the process of fine-tuning large-scale models such as a language model or a vision model, a typical performance evaluation method may not effectively prevent overfitting and may not effectively minimize bias that may occur while a new task is being learned.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes randomly generating a plurality of orderings of tasks for a plurality of tasks of a training dataset, determining, based on training a first base model using the training dataset according to each of the plurality of orderings of tasks, an evaluation information set of the first base model trained according to each of the plurality of orderings of tasks, and determining, based on the evaluation information set of the first base model trained according to each of the orderings of tasks, a piece of first target evaluation information of the first base model corresponding to the training dataset.

The determining of, based on training the first base model using the training dataset according to each of the plurality of orderings of tasks, the evaluation information set of the first base model trained according to each of the plurality of orderings of tasks may include determining, based on training the first base model using the training dataset according to a first ordering of tasks among the plurality of orderings of tasks, a piece of first evaluation information of the first base model trained according to the first ordering of tasks, and determining, based on training the first base model using the training dataset according to each of one or more orderings of tasks other than the first ordering of tasks among the plurality of orderings of tasks, one or more pieces of evaluation information of the first base model trained according to each of the one or more orderings of tasks.

The determining of, based on the evaluation information set of the first base model trained according to each of the plurality of orderings of tasks, the piece of first target evaluation information of the first base model corresponding to the training dataset may include determining an average of the piece of first evaluation information and the one or more pieces of evaluation information as the piece of first target evaluation information of the first base model corresponding to the training dataset.

The training dataset may include a support set and a query set corresponding to each of the plurality of tasks.

The support set may include support samples corresponding to one or more classes.

The query set may include query samples corresponding to one or more classes.

The determining of, based on training the first base model using the training dataset according to the first ordering of tasks among the plurality of orderings of tasks, the piece of first evaluation information of the first base model trained according to the first ordering of tasks may include training the first base model according to the first ordering of tasks using a support set corresponding to each of the plurality of tasks of the training dataset, and determining the piece of first evaluation information of the first base model trained according to the first ordering of tasks using a query set corresponding to each of the plurality of tasks of the training dataset.

The determining of the piece of first evaluation information of the first base model trained according to the first ordering of tasks using the query set corresponding to each of the plurality of tasks of the training dataset may include predicting a label of a query sample comprised in the query set through the first base model trained according to the first ordering of tasks, and determining the piece of first evaluation information based on comparing the predicted label with a ground truth label of the query sample.

The determining of, based on training the first base model using the training dataset according to the first ordering of tasks among the plurality of orderings of tasks, the piece of first evaluation information of the first base model trained according to the first ordering of tasks may include training the first base model using a first support set corresponding to a first task among the plurality of tasks according to the first ordering of tasks, determining, using a first query set corresponding to the first task, a piece of first interim evaluation information of the first base model trained using the first support set, sequentially training, using one or more support sets respectively corresponding to one or more tasks subsequent to the first task among the plurality of tasks, the first base model trained using the first support set according to the first ordering of tasks, determining, using one or more query sets respectively corresponding to the one or more tasks, one or more pieces of interim evaluation information of the sequentially trained first base model, and determining, based on the piece of first interim evaluation information and the one or more pieces of interim evaluation information, the piece of first evaluation information of the first base model trained according to the first ordering of tasks.

The method may include determining, based on training one or more base models other than the first base model according to each of the plurality of orderings of tasks of the training dataset, respective pieces of target evaluation information of the one or more base models corresponding to the training dataset, and generating a target base model by determining, based on the piece of first target evaluation information and the respective pieces of target evaluation information of the one or more base models, the target base model among the first base model and the one or more base models.

The method may include determining, based on an evaluation information set of the target base model trained according to each of the plurality of orderings of tasks using the training dataset, a target ordering of tasks among the plurality of orderings of tasks, and outputting the target base model trained according to the target ordering of tasks.

The method may include generating output data by inputting input data for performing a target task to a target base model trained according to the target ordering of tasks.

The first base model and the one or more base models may be pre-trained models.

In one or more general aspects, a non-transitory computer-readable storage medium may store instructions that, when executed by one or more processors, configure the one or more processors to perform any one, any combination, or all of operations and/or methods disclosed herein.

In one or more general aspects an electronic device includes one or more processors comprising processing circuitry, and memory comprising one or more storage media storing instructions that, when executed individually or collectively by the one or more processors, cause the electronic device to randomly generate a plurality of orderings of tasks for a plurality of tasks of a training dataset, determine, based on training a first base model using the training dataset according to each of the plurality of orderings of tasks, an evaluation information set of the first base model trained according to each of the plurality of orderings of tasks, and determine, based on the evaluation information set of the first base model trained according to each of the plurality of orderings of tasks, a piece of first target evaluation information of the first base model corresponding to the training dataset.

For the determining, based on training the first base model using the training dataset according to each of the plurality of orderings of tasks, of the evaluation information set of the first base model trained according to each of the plurality of orderings of tasks, the execution of the instructions may cause the electronic device to determine, based on training the first base model using the training dataset according to the first ordering of tasks among the plurality of orderings of tasks, a piece of first evaluation information of the first base model trained according to a first ordering of tasks, and determine, based on training the first base model using the training dataset according to each of one or more orderings of tasks other than the first ordering of tasks among the plurality of orderings of tasks, one or more pieces of evaluation information of the first base model trained according to each of the one or more orderings of tasks.

For the determining, based on the evaluation information set of the first base model trained according to each of the plurality of orderings of tasks, of the piece of first target evaluation information of the first base model corresponding to the training dataset, the execution of the instructions may cause the electronic device to determine an average of the piece of first evaluation information and the one or more pieces of evaluation information as the piece of first target evaluation information of the first base model corresponding to the training dataset.

The training dataset may include a support set and a query set corresponding to each of the plurality of tasks.

The support set may include support samples corresponding to one or more classes.

In one or more general aspects, a processor-implemented method includes determining, by training a base model based on an ordering of tasks among a plurality of randomly generated orderings of tasks of a training dataset, a piece of evaluation information of the base model, and
determining, by training the base model based on each of one or more other orderings of tasks among the plurality of orderings of tasks, one or more other pieces of evaluation information of the base model, and generating a target base model based on an evaluation information set comprising the piece and the one or more other pieces of evaluation information.

Other features and aspects will be apparent from the following detailed description, the drawings, and the claims.

### BRIEF DESCRIPTION OF THE DRAWINGS

FIG. 1 illustrates an example of a model learning system, according to one or more embodiments.

FIG. 2 illustrates an example of a dataset for few-shot class incremental learning (FSCIL) according to one or more embodiments.

FIG. 3 illustrates an example of an electronic device, according to one or more embodiments.

FIG. 4 illustrates an example of a method of evaluating a model, according to one or more embodiments.

FIG. 5 illustrates an example of a method of determining a piece of target evaluation information of a base model, according to one or more embodiments.

FIG. 6 illustrates an example of a method of determining a piece of evaluation information of a base model trained according to a predetermined ordering of tasks, according to one or more embodiments.

FIG. 7 illustrates an example of a method of generating a target base model, according to one or more embodiments.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Hereinafter, examples are described in detail with reference to the accompanying drawings. When describing the examples with reference to the accompanying drawings, like reference numerals refer to like components, and any repeated description related thereto will be omitted.

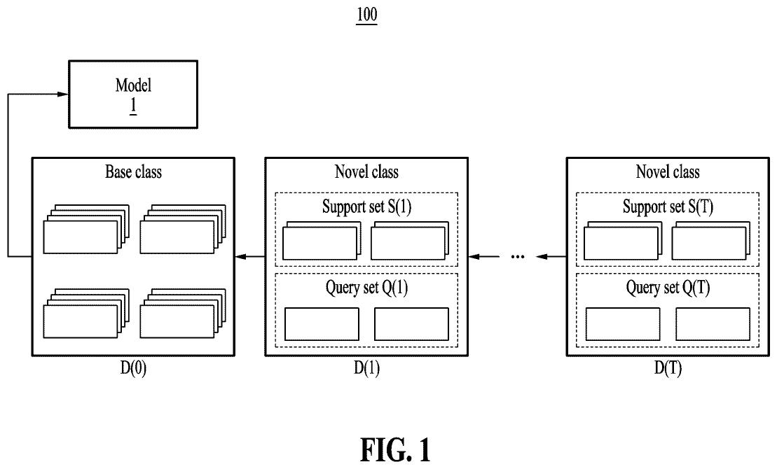

FIG. 1 illustrates an example of a model learning system, according to one or more embodiments.

A model learning system 100 may be a system for training a model 1 with new knowledge over a series of learning sessions. A learning session may also be referred to as a task. The model 1 may be, for example, a neural network model or a deep learning model such as a transformer. A method and electronic device of one or more embodiments may prevent overfitting and minimize bias that may occur while a new task is being learned.

As illustrated in FIG. 1, the model learning system 100 may incrementally train the model 1 using a dataset (D(t)) for each task (t, 0≤t≤T). The task may be a classification task such as image classification or text classification, for example.

The dataset may include samples for training the model 1. A sample may be data included in a dataset and may also be referred to as an example or an instance.

The model learning system 100 may train the model 1 using a dataset (D(0)) for a task (t=0) (e.g., a source task). The dataset for a source task may include samples related to base classes. The model 1 trained using the samples related to the base classes may be referred to as a “base model”. In an example, prior to any subsequent training, the base model may have been trained using the dataset D(0) but may not have been trained using datasets D(1) through D(T).

In the model learning system 100, the model 1 may pre-learn using D(0). D(0) may include a relatively large number or quantity of samples related to the base classes. For example, D(0) may be a large dataset including labeled samples, each of which has a label (e.g., a ground truth label). The model 1 may learn, using D(0), characteristics and/or patterns of samples of D(0) by performing a task of classifying the base classes.

In the model learning system 100, the model 1 may learn, using D(0), how to learn (e.g., meta-learn) such that the model 1 may adapt to a new task.

The model learning system 100 may be a few-shot class incremental learning (FSCIL) system. The model learning system 100 may incrementally train a base model using datasets ( D(1), . . . , D(T)) including a very small number of samples related to a novel class as in an one-shot or few-shot scenario. In the FSCIL system, a dataset (D(t), 1≤t≤T) for each of T tasks may include samples related to a novel class not included in a dataset for other tasks.

The dataset (D(t)) for a predetermined task (t) may include a support set (S(t)) and a query set (Q(t)).

The support set may be a dataset for training a base model to classify novel classes. The support set may also be referred to as a reference set.

The query set may be a dataset for evaluating a training result according to the support set. The query set may also be referred to as a validation set or a test set. In the FSCIL system, fine-tuning for a novel class may be performed using a support set and a query set corresponding to each task for training the base model.

The FSCIL system may train the base model using an n-way k-shot support set for each task. The n-way k-shot support set may be a case in which a support set corresponding to each task includes samples (e.g., support samples) related to n classes, and the number of samples for each class is k.

For each task, the FSCIL system may evaluate, using the query set, the base model trained using the support set. For example, the FSCIL system may evaluate, using a first query set (Q(1)), a base model trained using a first support set (S(1)). The FSCIL system may evaluate, using a query set (e.g., Q(t−1), etc.) corresponding to a previous task as well as a query set (Q(t)) corresponding to a corresponding task, the base model trained using a support set ( S(t)) corresponding to a predetermined task (e.g., a current task) (t) in order to verify whether catastrophic forgetting for an existing class occurs due to learning related to novel classes.

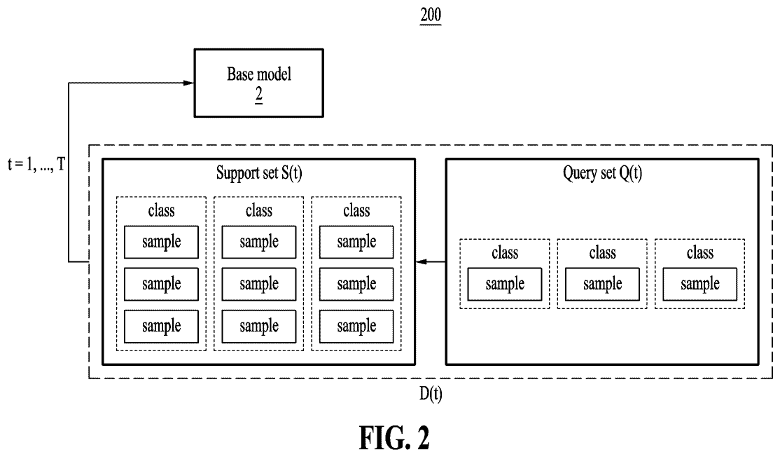

FIG. 2 illustrates an example of a dataset for FSCIL, according to one or more embodiments.

A model learning system 200 (e.g., the model learning system 100 of FIG. 1) may be a system for training a base model 2 with new knowledge. As described with reference to FIG. 1, the base model 2 may be the model 1 trained using samples related to base classes of a dataset for a source task. The base model 2 may be, for example, a neural network model or a deep learning model such as a transformer.

The model learning system 200 may obtain a basic dataset. The model learning system 200 may generate a dataset related to base classes and a dataset related to novel classes by performing sampling on the basic dataset. For example, the dataset related to base classes may be a dataset for pre-learning of the model 1 like the dataset (D(0)) of FIG. 1.

The model learning system 200 may be an FSCIL system. In the model learning system 200, a dataset related to novel classes may be referred to as a “training dataset” for FSCIL.

The model learning system 200 may generate a dataset for each of a plurality of tasks by performing sampling on a training dataset. For example, the model learning system 200 may generate a dataset (D(t) , 1≤t≤T) for each of T tasks. The dataset for each of the plurality of tasks may include a support set (S(t)) and a query set (Q(t)). The model learning system 200 may be understood as generating a support set and a query set corresponding to each of the plurality of tasks by performing sampling on the training data set.

The model learning system 200 may generate an n-way k-shot support set corresponding to each of the plurality of tasks. The n-way k-shot support set corresponding to a predetermined task (t) may include support samples related to n classes, and the number of support samples per class may be k. Each of the support samples included in the support set may have a label (e.g., a ground truth label).

The model learning system 200 may generate a query set corresponding to each of the plurality of tasks. A query set corresponding to the predetermined task (t) may include query samples related to n classes. For example, the number of query samples per class of the query set corresponding to the predetermined task (t) may be one or more. Each of the query samples included in the query set may have a label (e.g., a ground truth label).

For example, the model learning system 200 may obtain a basic dataset related to 200 classes. The model learning system 200 may generate a dataset related to 100 base classes and a dataset (e.g., a training dataset) related to 100 novel classes by performing sampling on the basic dataset. The model learning system 200 may generate, for example, a 10-way 5-shot support set corresponding to each of 10 tasks by performing sampling on the training dataset. The 10-way 5-shot support set corresponding to a predetermined task may include support samples related to 10 classes, and the number of support samples per class may be 5. The number of classes of the basic dataset, training dataset, and support set described above are only examples, and examples are not limited thereto.

The model learning system 200 may train the base model 2 according to a predetermined ordering of tasks (e.g., a sequence of tasks) for the plurality of tasks.

For example, the model learning system 200 may train the base model 2 for three tasks, such as a first task, a second task, and a third task, according to the predetermined ordering of tasks. For example, when training the base model 2 in the order of the first task, the second task, and the third task, the model learning system 200 may first train the base model 2 using the first support set corresponding to the first task. The model learning system 200 may evaluate the trained base model 2 using the first support set and the first query set corresponding to the first task.

The model learning system 200 may sequentially (e.g., incrementally) train, using one or more support sets respectively corresponding to one or more tasks subsequent to the first task, the base model 2 trained using the first support set according to the ordering of tasks. The model learning system 200 may evaluate the base model 2 that is sequentially trained using one or more query sets respectively corresponding to one or more tasks in response to the base model 2 being trained for the first task. For example, the model learning system 200 may train, using a second support set corresponding to the second task, the base model 2 trained using the first support set. The model learning system 200 may evaluate, using a second query set corresponding to the second task, the base model 2 trained using the second support set. The model learning system 200 may also evaluate, using the first query set as well as the second query set, the base model 2 trained using the second support set.

The model learning system 200 may incrementally train and evaluate various models (e.g., base models) as well as the base model 2 illustrated in FIG. 2 using the training dataset. The model learning system 200 may adjust each model, for example, by updating parameters such as a weight and/or a bias of the model (e.g., the base model 2) based on an evaluation result. However, by training and evaluating according to the predetermined ordering of tasks for the plurality of tasks of the training dataset, a typical model learning system may cause inadvertent overfitting in the trained base model 2 due to the ordering of tasks when the model is adjusted.

In contrast, the model learning system 200 of one or more embodiments may include a model learning method that minimizes the impact of an ordering of tasks on training and evaluation of the base model 2, thereby preventing overfitting of the base model 2. The model learning system 200 (e.g., an FSCIL system) of one or more embodiments may include a model evaluation method for evaluating the accurate performance of different models (e.g., model algorithms) and minimizing the impact of an ordering of tasks on training and evaluation of a predetermined model (e.g., the base model 2).

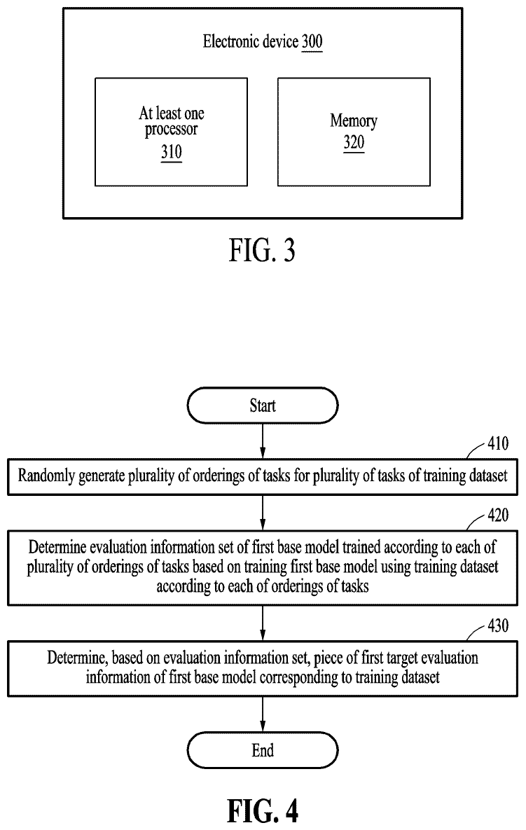

FIG. 3 illustrates an example of an electronic device, according to one or more embodiments.

An electronic device 300 may include at least one processor (e.g., one or more processors, hereinafter, “processor”) 310 including processing circuitry and a memory 320 (e.g., one or more memories) including one or more storage media storing instructions. When executed individually or collectively by the processor 310, the instructions may cause the electronic device 300 to perform one or more of the operations described with reference to FIGS. 1 to 7 of the present disclosure. For example, the memory 320 may be or include a non-transitory computer-readable storage medium storing instructions that, when executed by the processor 310, configure the processor 310 to perform any one, any combination, or all of operations and/or methods disclosed herein with reference to FIGS. 1-7.

The electronic device 300 may include a communicator (not shown) that is connected to the processor 310 and the memory 320 to transmit and receive data to and from the processor 310 and the memory 320. The communicator may be connected to another external device and transmit and receive data to and from the external device. Hereinafter, transmitting and receiving “A” may refer to transmitting and receiving “information or data indicating A”.

The communicator may be implemented as circuitry in the electronic device 300. For example, the communicator may include an internal bus and an external bus. In another example, the communicator may be an element that connects the electronic device 300 to the external device. The communicator may be an interface. The communicator may receive data from the external device and may transmit the data to the processor 310 and the memory 320.

The processor 310 may process data received by the communicator and/or data stored in the memory 320. A “processor” may be a hardware-implemented data processing device having a physically structured circuit to execute desired operations. For example, the desired operations may include code or instructions included in a program. For example, the hardware-implemented data processing device may include a microprocessor, a central processing unit (CPU), a graphics processing unit (GPU), a processor core, a multi-core processor, a multiprocessor, an application-specific integrated circuit (ASIC), and/or a field-programmable gate array (FPGA).

The processor 310 may control other components (e.g., a hardware or software component) of the electronic device 300 and may perform various types of data processing or operations. As at least a part of data processing or operations, the processor 310 may store instructions or data received from another component (e.g., the communicator) in at least a portion of the memory 320, may process the instructions or the data stored in the memory 320, and may store result data in the memory 320. Operations performed by the processor 310 may be substantially the same as the operations of the electronic device 300.

The memory 320 may store information necessary for the processor 310 to perform a processing operation. The memory 320 (e.g., one or more storage media included in the memory 320) may store instructions executed by the processor 310 and may store related information while software or a program is executed by the electronic device 300. For example, the memory 320 may include one or more memories, which are volatile and/or non-volatile memories known in the field, like random-access memory (RAM), dynamic RAM (DRAM), static RAM (SRAM), non-volatile RAM (NVRAM), persistent memory (PMEM), magneto-resistive RAM (MRAM), high bandwidth memory (HBM), and/or 3DXPoint.

The electronic device 300 may be connected to an external memory through the communicator. For example, the external memory may include one or more volatile memories, non-volatile memories and RAM, flash memories, hard disk drives, and optical disc drives. The external memory may store an instruction set (e.g., software) for operating the electronic device 300. The instruction set for operating the electronic device 300 may be executed by the processor 310.

FIG. 4 illustrates an example of a method of evaluating a model, according to one or more embodiments.

Operations 410 to 430 below may be performed by an electronic device (e.g., the electronic device 300 of FIG. 3). The electronic device may include one or more of the components of the electronic device 300 described with reference to FIG. 3. For example, the electronic device may include at least one processor (e.g., the at least one processor 310 of FIG. 3). The electronic device may include a memory (e.g., the memory 320 of FIG. 3). Operations 410 to 430 of FIG. 4 may be performed in the sequence and manner as illustrated in FIG. 4. However, one or more of the operations may be performed in a different order, one or more of the operations may be omitted, two or more of the operations may be performed in parallel or simultaneously, and/or other operations may be additionally performed without departing from the spirit and scope of the described embodiments.

The electronic device may obtain a basic dataset. The electronic device may generate a dataset related to base classes and a dataset related to novel classes by performing sampling on the basic dataset. The dataset related to novel classes may be referred to as a “training dataset” for FSCIL.

The electronic device may generate a dataset (D(t)) for each of a plurality of tasks by performing sampling on a training dataset. A dataset for a predetermined task may include samples related to novel classes that are not included in a dataset for other tasks. The dataset for each of the plurality of tasks may include a support set (S(t)) and a query set (Q(t)).

The training dataset may be understood as including a support set and a query set corresponding to each of the plurality of tasks. The support set may include support samples related to one or more classes. The query set may include query samples related to one or more classes.

The electronic device may train a first model (e.g., the model 1 of FIG. 1) using a dataset related to base classes. For example, the first model may be a neural network model or a deep learning model such as a transformer. The first model trained using the dataset related to base classes may be referred to as a “first base model”.

The electronic device may obtain a pre-trained first base model (e.g., the base model 2 of FIG. 2). For example, the first base model may be a model (e.g., the model 1 of FIG. 1) pre-trained using a large dataset including labeled samples, such as the dataset related to base classes described above.

In operation 410, the electronic device may randomly generate a plurality of orderings of tasks (e.g., sequences of tasks) for a plurality of tasks of a training dataset.

The maximum number of orderings of tasks generated for T (T≥2) tasks may be T!. For example, the maximum number of orderings of tasks that may be generated for three tasks (A, B, and C) may be 3!=6 (ABC, ACB, BAC, BCA, CAB, and CBA).

For example, the electronic device may randomly generate N orderings of tasks (2≤N≤T!) for T tasks of the training dataset. The number (N) of randomly generated orderings of tasks may be equal to or less than the maximum number of orderings of tasks that may be generated for the plurality of tasks.

In operation 420, the electronic device may determine an evaluation information set of the first base model trained according to each of the plurality of orderings of tasks based on training the first base model according to the plurality of orderings of tasks using the training dataset.

The evaluation information set may include a piece of evaluation information of the first base model trained according to each of the orderings of tasks. When there are N orderings of tasks (e.g., a first ordering of tasks, . . . , and an N-th ordering of tasks), the evaluation information set may include pieces of evaluation information (e.g., a piece of first evaluation information, . . . , and a piece of N-th evaluation information) of the first base model trained according to each of the orderings of tasks.

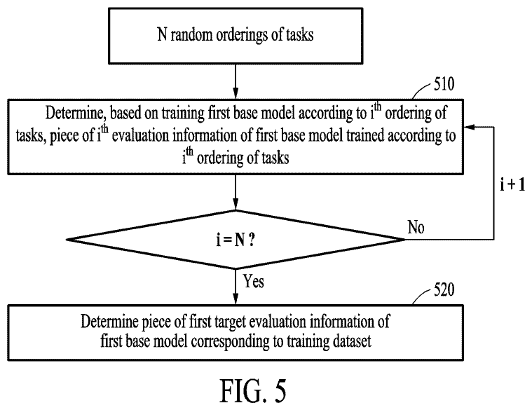

An example of a method of determining the evaluation information set of the first base model trained according to each of the plurality of orderings of tasks is described in detail with reference to FIG. 5.

In operation 430, the electronic device may determine, based on the evaluation information set of the first base model trained according to each of the plurality of orderings of tasks, a piece of first target evaluation information of the first base model related to the training dataset.

The electronic device may determine an average of pieces of evaluation information set as the piece of first target evaluation information of the first base model related to the training dataset. The electronic device may determine, as the piece of first target evaluation information of the first base model related to the training dataset, an average of the pieces of evaluation information (e.g., a piece of first evaluation information, . . . , and a piece of N^{th} evaluation information) of the first base model trained N times according to each of the orderings of tasks.

FIG. 5 illustrates an example of a method of determining a piece of target evaluation information of a base model, according to one or more embodiments.

Operations 510 and 520 below may be performed by an electronic device (e.g., the electronic device 300 of FIG. 3). The electronic device may include one or more of the components of the electronic device 300 described with reference to FIG. 3. For example, the electronic device may include at least one processor (e.g., the at least one processor 310 of FIG. 3). The electronic device may include a memory (e.g., the memory 320 of FIG. 3). Operations 510 to 520 of FIG. 5 may be performed in the sequence and manner as illustrated in FIG. 5. However, one or more of the operations may be performed in a different order, one or more of the operations may be omitted, two or more of the operations may be performed in parallel or simultaneously, and/or other operations may be additionally performed without departing from the spirit and scope of the described embodiments.

As described with reference to FIG. 4, the electronic device may randomly generate a plurality of orderings of tasks for a plurality of tasks for a training dataset. For example, the electronic device may randomly generate N orderings of tasks (2≤N≤T!) for T tasks of the training dataset.

Operation 420 of determining the evaluation information set of the first base model trained according to each of the plurality of orderings of tasks described with reference to FIG. 4 may include operation 510.

In operation 510, the electronic device may determine a piece of i^{th} evaluation information of the first base model trained according to an i^{th} ordering of tasks based on training the first base model (e.g., the base model 2 of FIG. 2) according to the i^{th} ordering of tasks using the training dataset (1≤i≤N, i=i+1).

The electronic device may train the first base model according to the i^{th} ordering of tasks using a support set corresponding to each of the plurality of tasks of the training dataset. The electronic device may determine the piece of i^{th} evaluation information of the first base model trained according to the i^{th} ordering of tasks using a query set corresponding to each of the plurality of tasks of the training dataset.

The electronic device may predict labels of query samples included in the query set through the first base model trained according to the i^{th} ordering of tasks. The electronic device may determine the piece of i^{th} evaluation information of the first base model trained according to the i^{th} ordering of tasks based on comparing a predicted labels and a ground truth label of the query samples included in the query set. For example, the electronic device may determine, as the piece of i^{th} evaluation information, an error or a loss between the predicted label and the ground truth label of the query samples included in the query set. For example, the electronic device may determine, as the piece of i^{th} evaluation information, accuracy indicating the proportion of correctly predicted query samples, based on comparing the predicted labels with the ground truth label of the query samples included in the query set.

When there are N orderings of tasks (e.g., a first ordering of tasks, . . . , and an N^{th} ordering of tasks), the electronic device may repeatedly (e.g., iteratively) perform operation 510 N times according to each of the orderings of tasks. When there are N orderings of tasks, the electronic device may replicate the first base model N times. The electronic device may independently perform operation 510 N times for each of the N first base models, according to each of the orderings of tasks. The electronic device may perform operation 510 N times in parallel for each of the N first base models, according to each of the orderings of tasks.

The electronic device may determine the evaluation information set of the first base model by training and evaluating the first base model according to each of the orderings of tasks using the training dataset. The evaluation information set may include pieces of evaluation information (e.g., a piece of first evaluation information, . . . , and a piece of N^{th} evaluation information) according to each of the orderings of tasks.

In operation 520, the electronic device may determine, based on the evaluation information set of the first base model trained according to each of the plurality of orderings of tasks, a piece of first target evaluation information of the first base model related to the training dataset.

The electronic device may determine an average of pieces of evaluation information set as the piece of first target evaluation information of the first base model related to the training dataset.

For example, the electronic device may determine the piece of first evaluation information of the first base model trained according to the first ordering of tasks based on training the first base model according to the first ordering of tasks among the plurality of orderings of tasks using the training dataset. First, the electronic device may train the first base model according to the first ordering of tasks using the support set corresponding to each of the plurality of tasks of the training dataset. The electronic device may determine the piece of first evaluation information of the first base model trained according to the first ordering of tasks using the query set corresponding to each of the plurality of tasks of the training dataset.

The electronic device may determine one or more pieces of evaluation information (e.g., a piece of second evaluation information, . . . , and the piece of N^{th} evaluation information) of the first base model trained according to each of one or more orderings of tasks (e.g., a second ordering of tasks, . . . , and the N^{th} ordering of tasks) other than the first ordering of tasks among the plurality of orderings of tasks, based on training the first base model according to each of the one or more orderings of tasks. The electronic device may perform the operations of determining each piece of evaluation information of the evaluation information set sequentially or in parallel. The electronic device may determine an average of the piece of first evaluation information and the one or more pieces of evaluation information as the piece of first target evaluation information of the first base model related to the training dataset.

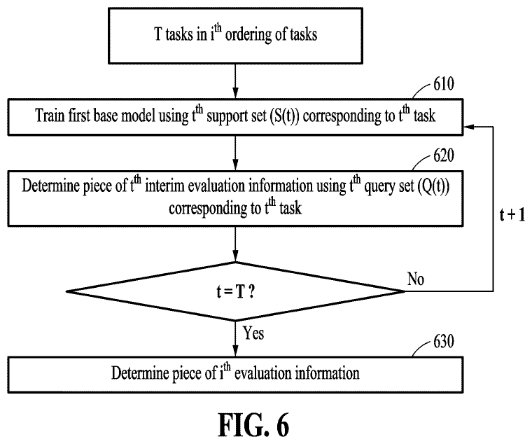

FIG. 6 illustrates an example of a method of determining a piece of evaluation information of a base model trained according to a predetermined ordering of tasks, according to one or more embodiments.

Operations 610 to 630 below may be performed by an electronic device (e.g., the electronic device 300 of FIG. 3). The electronic device may include one or more of the components of the electronic device 300 described with reference to FIG. 3. For example, the electronic device may include at least one processor (e.g., the at least one processor 310 of FIG. 3). The electronic device may include a memory (e.g., the memory 320 of FIG. 3). Operations 610 to 630 of FIG. 6 may be performed in the sequence and manner as illustrated in FIG. 6. However, one or more of the operations may be performed in a different order, one or more of the operations may be omitted, two or more of the operations may be performed in parallel or simultaneously, and/or other operations may be additionally performed without departing from the spirit and scope of the described embodiments.

As described with reference to FIG. 4, the electronic device may randomly generate a plurality of orderings of tasks for a plurality of tasks for a training dataset. For example, the electronic device may randomly generate N orderings of tasks (2≤N≤T!) for T tasks of the training dataset.

Operation 510 of determining the piece of i^{th} evaluation information of the first base model (e.g., the base model 2 of FIG. 2) trained according to the i^{th} ordering of tasks of FIG. 5 may include operations 610 to 630 (1≤i≤N).

In operation 610, the electronic device may train the first base model using a t^{th} support set (S(t)) corresponding to a t^{th} task among a plurality of tasks according to the i^{th} ordering of tasks.

In operation 620, the electronic device may determine, using a t^{th} query set (Q(t)) corresponding to the t^{th} task, a piece of t^{th} interim evaluation information of the first base model trained using the t^{th} support set (1≤t≤T, t=t+1).

The electronic device may predict a label of a query sample of the t^{th} query set corresponding to the t^{th} task through the first base model trained using the t^{th} support set corresponding to t^{th} task. The electronic device may determine the piece of t^{th} interim evaluation information of the first base model trained using the t^{th} support set based on comparing the predicted label with the ground truth label of the query sample of the t^{th} query set. For example, the electronic device may determine, as the piece of t^{th} interim evaluation information, an error or a loss between the predicted label and the ground truth label of the query sample included in the t^{th} query set. For example, the electronic device may determine, as the piece of t^{th} interim evaluation information, accuracy indicating the proportion of correctly predicted query samples, based on comparing the predicted label with the ground truth label of the query sample included in the t^{th} query set.

When there are T tasks (e.g., a first task, . . . , and a T^{th} task), the electronic device may sequentially (e.g., incrementally) perform operations 610 and 620 T times for each task according to the i^{th} ordering of tasks. The electronic device may sequentially (e.g., incrementally) train the first base model using the support set corresponding to each task according to the i^{th} ordering of tasks. The electronic device may determine pieces of interim evaluation information (e.g., a piece of first interim evaluation information, . . . , and a piece of T^{th} interim evaluation information) of the first base model that is sequentially trained using a query set corresponding to each task.

In operation 630, the electronic device may determine the piece of i^{th} evaluation information of the first base model trained according to the i^{th} ordering of tasks based on the pieces of interim evaluation information sequentially determined according to the i^{th} ordering of tasks.

The electronic device may determine an average of the pieces of interim evaluation information sequentially determined according to the i^{th} ordering of tasks as the piece of i^{th} evaluation information of the first base model trained according to the i^{th} ordering of tasks.

For example, the electronic device may train the first base model using a first support set (S(1)) corresponding to a first task among the plurality tasks according to a first ordering of tasks among the plurality of orderings of tasks. The electronic device may determine the piece of first interim evaluation information of the first base model trained using the first support set using a first query set (Q(1)) corresponding to the first task.

Using one or more support sets (S(2), . . . , and S(T)) respectively corresponding to one or more tasks subsequent to the first task among the plurality of tasks according to the first ordering of tasks, the electronic device may sequentially (e.g., incrementally) train the first base model trained using the first support set. Using one or more query sets (Q(2), . . . , and Q(T)) respectively corresponding to one or more tasks, the electronic device may determine one or more pieces of interim evaluation information (e.g., a piece of second interim evaluation information, . . . , and the piece of T^{th} interim evaluation information) of the sequentially trained first base model. The electronic device may determine the piece of first evaluation information of the first base model trained according to the first ordering of tasks based on the piece of first interim evaluation information and one or more pieces of interim evaluation information. The electronic device may determine an average of the piece of first interim evaluation information and the one or more pieces of interim evaluation information as the piece of first evaluation information of the first base model trained according to the first ordering of tasks.

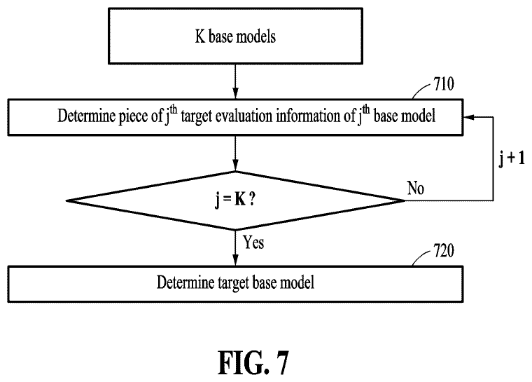

FIG. 7 illustrates an example of a method of generating a target base model, according to one or more embodiments.

Operations 710 and 720 below may be performed by an electronic device (e.g., the electronic device 300 of FIG. 3). The electronic device may include one or more of the components of the electronic device 300 described with reference to FIG. 3. For example, the electronic device may include at least one processor (e.g., the at least one processor 310 of FIG. 3). The electronic device may include a memory (e.g., the memory 320 of FIG. 3). Operations 710 to 720 of FIG. 7 may be performed in the sequence and manner as illustrated in FIG. 7. However, one or more of the operations may be performed in a different order, one or more of the operations may be omitted, two or more of the operations may be performed in parallel or simultaneously, and/or other operations may be additionally performed without departing from the spirit and scope of the described embodiments.

The electronic device may obtain a plurality of base models (e.g., the base model 2 of FIG. 2). For example, the electronic device may obtain K base models.

As described above with reference to FIG. 4, the electronic device may train a first model (e.g., the model 1 of FIG. 1) using a dataset related to base classes. The electronic device may train one or more models (e.g., the model 1 of FIG. 1) that are different from the first model using a dataset that is the same as or different from the dataset used to train the first model. For example, the first model and each of the one or more models may be models having the same or different model architectures, parameters, and/or hyperparameters such as an optimizer, a loss function, a learning rate, and/or an augmentation technique of a dataset. Datasets for respectively training the one or more models may be the same as or different from one another. Each of the models trained using the same dataset or different datasets may be referred to as a “base model (e.g., a first base model, a second base model, . . . )”.

As described above with reference to FIG. 4, the electronic device may obtain a pre-trained first base model (e.g., the base model 2 of FIG. 2). The electronic device may obtain one or more pre-trained base models (e.g., the base model 2 of FIG. 2) other than the first base model. For example, the first base model and each of the one or more base models may be pre-trained using the same dataset or different datasets. The first base model and each of the one or more base models may be base models having the same or different model architectures, parameters, and/or hyperparameters such as an optimizer, a loss function, a learning rate, and/or an augmentation technique of a dataset.

One or more of a plurality of base models obtained by the electronic device may be pre-trained by the electronic device, and one or more others may be obtained after being pre-trained.

In operation 710, the electronic device may determine a piece of j^{th} target evaluation information (1≤j≤K, j=j+1) of a j^{th} base model related to the training dataset based on training the j^{th} base model according to each of the plurality of orderings of tasks of the training dataset.

Operation 710 may include operations 410 to 430 of FIG. 4. When there are K base models (e.g., a first base model, . . . , and a K^{th} base model), the electronic device may repeatedly perform operations 410 to 430 K times for each base model.

In operation 720, the electronic device may determine a target base model among the plurality of base models based on a piece of target evaluation information of each of the plurality of base models.

The electronic device may determine, as the target base model with the best performance, a base model of which a corresponding piece of target evaluation information satisfies a determined condition among the plurality of base models. For example, the electronic device may determine, as the target base model, a base model with the highest accuracy indicated by the corresponding piece of target evaluation information among the plurality of base models. For example, the electronic device may determine, as the target base model, a base model with the lowest error or loss indicated by the corresponding piece of target evaluation information among the plurality of base models.

For example, the electronic device may determine a piece of first target evaluation information of the first base model related to the training dataset based on training the first base model according to each of the plurality of orderings of tasks of the training dataset.

The electronic device may determine a piece of target evaluation information (e.g., a piece of second target evaluation information, . . . , and a piece of K^{th} target evaluation information) of each of the one or more base models related to the training dataset based on training one or more base models (e.g., a second base model, . . . , and the K^{th} base model) other than the first base model according to each of the plurality of orderings of tasks of the training dataset. The electronic device may perform the operations of determining each piece of target evaluation information sequentially or in parallel. The electronic device may determine a target base model among the first base model and the one or more base models based on the piece of first target evaluation information and the piece of target evaluation information of each of the one or more base models.

The electronic device may determine a target ordering of tasks having the best FSCIL performance among the plurality of orderings of tasks based on an evaluation information set of the target base model trained according to each of the plurality of orderings of tasks using the training dataset. When there are N orderings of tasks (e.g., a first ordering of tasks, . . . , and an N^{th} ordering of tasks), the evaluation information set of the target base model may include a piece of evaluation information (e.g., a piece of first evaluation information, . . . , and a piece of N^{th} evaluation information) of the target base model trained according to each of the orderings of tasks. For example, the electronic device may determine, as a target ordering of tasks, an ordering of tasks with the highest accuracy indicated by a piece of corresponding evaluation information in the evaluation information set of the target base model. For example, the electronic device may determine, as the target ordering of tasks, an ordering of tasks with the lowest error or loss indicated by the piece of corresponding evaluation information in the evaluation information set of the target base model. The electronic device may output the target base model trained according to the target ordering of tasks.

The electronic device may obtain input data (e.g., an image and a text) for performing a target task (e.g., a classification task). The electronic device may generate output data by inputting the input data for performing the target task to the target base model trained according to the target ordering of tasks.

In an FSCIL system (e.g., the model learning system 100 of FIG. 1 or the model learning system 200 of FIG. 2), the method and electronic device of one or more embodiments may minimize the influence of an ordering of tasks on the training and evaluation of a base model by training and evaluating the base model according to a plurality of orderings of tasks randomly generated for a plurality of tasks of a training dataset. In addition, by training and evaluating various base models according to the plurality of orderings of tasks randomly generated for the plurality of tasks for the training dataset, the method and electronic device of one or more embodiments may accurately and efficiently evaluate the accurate performance of different models. Therefore, the method and electronic device of one or more embodiments may prevent overfitting due to a predetermined ordering of tasks (e.g., a class incremental learning order), and may generate a trained model that is robust to various class incremental learning orders.

The model learning systems, electronic devices, processors, memories, model learning system 100, model learning system 200, electronic device 300, processor 310, and memory 320 described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-7 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
randomly generating a plurality of orderings of tasks for a plurality of tasks of a training dataset;
determining, based on training a first base model using the training dataset according to each of the plurality of orderings of tasks, an evaluation information set of the first base model trained according to each of the plurality of orderings of tasks; and
determining, based on the evaluation information set of the first base model trained according to each of the orderings of tasks, a piece of first target evaluation information of the first base model corresponding to the training dataset.

2. The method of claim 1, wherein the determining of, based on training the first base model using the training dataset according to each of the plurality of orderings of tasks, the evaluation information set of the first base model trained according to each of the plurality of orderings of tasks comprises:
determining, based on training the first base model using the training dataset according to a first ordering of tasks among the plurality of orderings of tasks, a piece of first evaluation information of the first base model trained according to the first ordering of tasks; and
determining, based on training the first base model using the training dataset according to each of one or more orderings of tasks other than the first ordering of tasks among the plurality of orderings of tasks, one or more pieces of evaluation information of the first base model trained according to each of the one or more orderings of tasks.

3. The method of claim 2, wherein the determining of, based on the evaluation information set of the first base model trained according to each of the plurality of orderings of tasks, the piece of first target evaluation information of the first base model corresponding to the training dataset comprises:
determining an average of the piece of first evaluation information and the one or more pieces of evaluation information as the piece of first target evaluation information of the first base model corresponding to the training dataset.

4. The method of claim 1, wherein the training dataset comprises a support set and a query set corresponding to each of the plurality of tasks.

5. The method of claim 4, wherein the support set comprises support samples corresponding to one or more classes.

6. The method of claim 4, wherein the query set comprises query samples corresponding to one or more classes.

7. The method of claim 2, wherein the determining of, based on training the first base model using the training dataset according to the first ordering of tasks among the plurality of orderings of tasks, the piece of first evaluation information of the first base model trained according to the first ordering of tasks comprises:
training the first base model according to the first ordering of tasks using a support set corresponding to each of the plurality of tasks of the training dataset; and
determining the piece of first evaluation information of the first base model trained according to the first ordering of tasks using a query set corresponding to each of the plurality of tasks of the training dataset.

8. The method of claim 7, wherein the determining of the piece of first evaluation information of the first base model trained according to the first ordering of tasks using the query set corresponding to each of the plurality of tasks of the training dataset comprises:
predicting a label of a query sample comprised in the query set through the first base model trained according to the first ordering of tasks; and
determining the piece of first evaluation information based on comparing the predicted label with a ground truth label of the query sample.

9. The method of claim 2, wherein the determining of, based on training the first base model using the training dataset according to the first ordering of tasks among the plurality of orderings of tasks, the piece of first evaluation information of the first base model trained according to the first ordering of tasks comprises:
training the first base model using a first support set corresponding to a first task among the plurality of tasks according to the first ordering of tasks;
determining, using a first query set corresponding to the first task, a piece of first interim evaluation information of the first base model trained using the first support set;
sequentially training, using one or more support sets respectively corresponding to one or more tasks subsequent to the first task among the plurality of tasks, the first base model trained using the first support set according to the first ordering of tasks;
determining, using one or more query sets respectively corresponding to the one or more tasks, one or more pieces of interim evaluation information of the sequentially trained first base model; and
determining, based on the piece of first interim evaluation information and the one or more pieces of interim evaluation information, the piece of first evaluation information of the first base model trained according to the first ordering of tasks.

10. The method of claim 1, further comprising:
determining, based on training one or more base models other than the first base model according to each of the plurality of orderings of tasks of the training dataset, respective pieces of target evaluation information of the one or more base models corresponding to the training dataset; and
generating a target base model by determining, based on the piece of first target evaluation information and the respective pieces of target evaluation information of the one or more base models, the target base model among the first base model and the one or more base models.

11. The method of claim 10, further comprising:
determining, based on an evaluation information set of the target base model trained according to each of the plurality of orderings of tasks using the training dataset, a target ordering of tasks among the plurality of orderings of tasks; and
outputting the target base model trained according to the target ordering of tasks.

12. The method of claim 11, further comprising generating output data by inputting input data for performing a target task to a target base model trained according to the target ordering of tasks.

13. The method of claim 10, wherein the first base model and the one or more base models are pre-trained models.

14. A non-transitory computer-readable storage medium storing instructions that, when executed by one or more processors, configure the one or more processors to perform the method of claim 1.

15. An electronic device comprising:
one or more processors comprising processing circuitry; and
memory comprising one or more storage media storing instructions that, when executed individually or collectively by the one or more processors, cause the electronic device to:
randomly generate a plurality of orderings of tasks for a plurality of tasks of a training dataset;
determine, based on training a first base model using the training dataset according to each of the plurality of orderings of tasks, an evaluation information set of the first base model trained according to each of the plurality of orderings of tasks; and
determine, based on the evaluation information set of the first base model trained according to each of the plurality of orderings of tasks, a piece of first target evaluation information of the first base model corresponding to the training dataset.

16. The electronic device of claim 15, wherein, for the determining, based on training the first base model using the training dataset according to each of the plurality of orderings of tasks, of the evaluation information set of the first base model trained according to each of the plurality of orderings of tasks, the execution of the instructions causes the electronic device to:
determine, based on training the first base model using the training dataset according to the first ordering of tasks among the plurality of orderings of tasks, a piece of first evaluation information of the first base model trained according to a first ordering of tasks; and
determine, based on training the first base model using the training dataset according to each of one or more orderings of tasks other than the first ordering of tasks among the plurality of orderings of tasks, one or more pieces of evaluation information of the first base model trained according to each of the one or more orderings of tasks.

17. The electronic device of claim 16, wherein, for the determining, based on the evaluation information set of the first base model trained according to each of the plurality of orderings of tasks, of the piece of first target evaluation information of the first base model corresponding to the training dataset, the execution of the instructions causes the electronic device to determine an average of the piece of first evaluation information and the one or more pieces of evaluation information as the piece of first target evaluation information of the first base model corresponding to the training dataset.

18. The electronic device of claim 15, wherein the training dataset comprises a support set and a query set corresponding to each of the plurality of tasks.

19. The electronic device of claim 18, wherein the support set comprises support samples corresponding to one or more classes.

20. A processor-implemented method comprising:
determining, by training a base model based on an ordering of tasks among a plurality of randomly generated orderings of tasks of a training dataset, a piece of evaluation information of the base model; and
determining, by training the base model based on each of one or more other orderings of tasks among the plurality of orderings of tasks, one or more other pieces of evaluation information of the base model; and
generating a target base model based on an evaluation information set comprising the piece and the one or more other pieces of evaluation information.
